(19) United States
(12) Patent Application Publication
(10) Pub. No.: US 2020/0380471 A1
(43) Pub. Date: Dec. 3, 2020

(54) EMPLOYEE MATCHING SYSTEM

(71) Applicant: Canduit Connection, LLC, Athens, GA (US)

(72) Inventor: Steven M. Wommack, Athens, GA (US)

(21) Appl. No.: 16/870,230

(22) Filed: May 8, 2020

Related U.S. Application Data
(60) Provisional application No. 62/853,981, filed on May 29, 2019.

(51) Int. Cl. G06Q 10/10; G06Q 10/06; G06F 16/958; H04L 29/08; H04W 4/14

(52) U.S. Cl. CPC G06Q 10/1053; G06Q 10/063112; H04W 4/14; G06F 16/958; H04L 67/306; G06Q 10/107

(57) ABSTRACT

Disclosed are various approaches for an employee matching system. Information associated with an open position can be obtained from an employer. A plurality of user profiles that match the open position can be identified. Then, the system can notify an employer of the plurality of user profiles that match the open position.

### CROSS-REFERENCE TO RELATED APPLICATIONS

This application claims priority to, and the benefit of, U.S. Provisional Patent Application No. 62/853,981, entitled “EMPLOYEE MATCHING SYSTEM” and filed on May 29, 2019, which is incorporated by reference as if set forth herein in its entirety.

### BACKGROUND

Employers seeking to fill positions face a number of problems when attempting to find individuals to fill an open position within the organization. For example, when an employer uses a traditional job-board or job-advertising platform, such as a platform or service provided by INDEED®, MONSTER®, CAREERBUILDER®, the employer is often flooded with resume submissions by a large number of potential employees. However, often only a small fraction of these individuals satisfy the requirements for the position. Identifying the individuals who satisfy the requirements from the pool of applicants is often a manual and time-consuming process prone to errors such as failing to identify all qualified individuals.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of a network environment according to various embodiments of the present disclosure.

FIG. 1B is a user interface diagram rendered on a display of a client device within the network environment of FIG. 1A according to various embodiments of the present disclosure.

FIG. 1C is a user interface diagram rendered on a display of a client device within the network environment of FIG. 1A according to various embodiments of the present disclosure.

FIG. 2 is a flowchart illustrating one example of functionality implemented as portions of an application executed in a computing environment in the network environment of FIG. 1A according to various embodiments of the present disclosure.

FIG. 3 is a schematic block diagram that provides one example illustration of a computing environment employed in the network environment of FIG. 1A according to various embodiments of the present disclosure.

### DETAILED DESCRIPTION

Disclosed are various approaches for matching job seekers to potential employers. Individuals can create profiles to represent themselves and identify particular industries they are interested in working, their general qualifications, employment history, and other relevant data. Likewise, employers can create and post their own profiles, which can include information related to job openings the employer is attempting to fill. Employers can then be automatically matched with individuals who may be qualified for the position, allowing employers to contact directly qualified individuals while surfacing potential employment opportunities to individuals that might not have been aware of the job openings. In the following discussion, a general description of the system and its components is provided, followed by a discussion of the operation of the same.

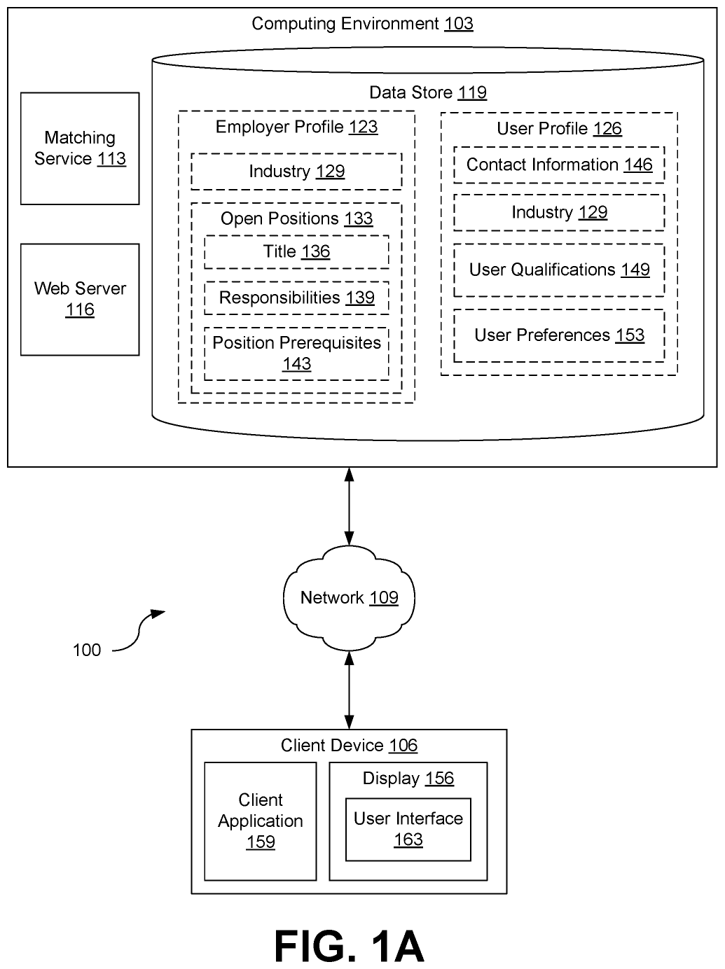

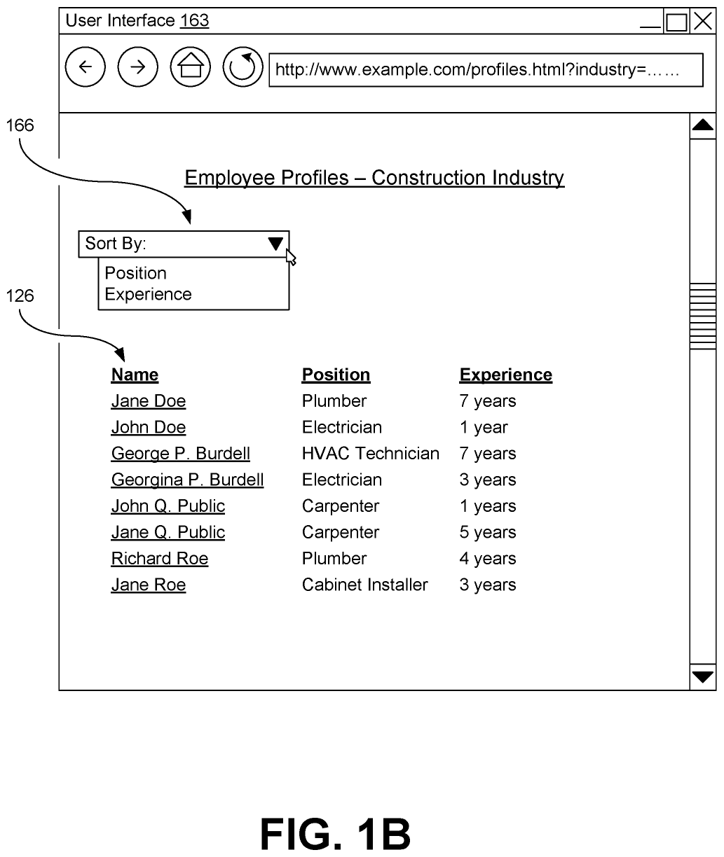

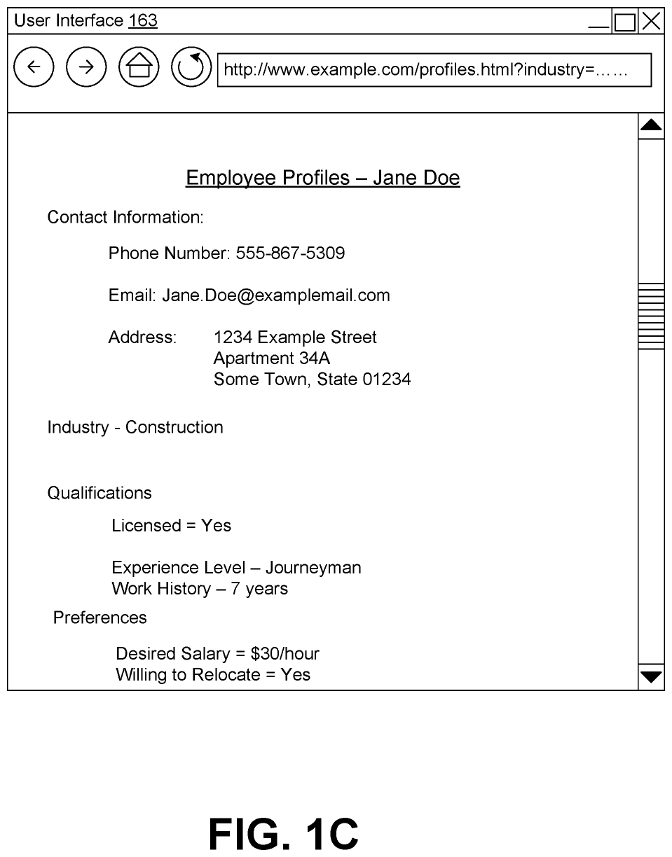

As illustrated in FIG. 1A, shown is a network environment 100 according to various embodiments. The network environment 100 includes a computing environment 103 and at least one client device 106, which are in data communication with each other via a network 109. The network 109 includes wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 may include, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may include a hosted computing resource, a grid computing resource or any other distributed computing arrangement. In some cases, the computing environment 103 may correspond to an elastic computing resource where the allotted capacity of processing, network, storage, or other computing-related resources may vary over time.

Various applications or other functionality may be executed in the computing environment 103 according to various embodiments. The components executed on the computing environment 103, for example, include matching service 113, a web server 116, and other applications, services, processes, systems, engines, or functionality not discussed in detail herein.

Also, various data is stored in a data store 119 that is accessible to the computing environment 103. The data store 119 may be representative of a plurality of data stores 119, which can include relational databases, object-oriented databases, hierarchical databases, hash tables or similar key-value data stores, as well as other data storage applications or data structures. The data stored in the data store 119 is associated with the operation of the various applications or functional entities described below. This data can include employer profiles 123, user profiles 126, and potentially other data.

The employer profile 123 represents information related to an individual employer (e.g., a company or individual who is attempting to hire someone) registered with the matching service 113. The employer profile 123 can identify the industry 129 of the employer, open positions 133 with the employer, and potentially other information.

The industry 129 can represent the general area of commerce in which the employer conducts operations. For example, the industry 129 may indicate that an employer is in the construction, hospitality, travel, transportation, logistics, healthcare, banking, automotive, retail, manufacturing, energy, residential services or commercial services industry, among others.

Individual open positions 133 may be stored in association with the employer profile 123. Each open position 133 can represent a job that the employer is recruiting to fill. Accordingly, an open position 133 can include information such as a title 136, responsibilities 139, position prerequisites 143, and potentially other information. The title 136 can represent the title of the job or position (e.g., welder, assistant manager, teller, relationship manager, receptionist, etc.). The responsibilities 139 can include a list of duties or responsibilities associated with the open position 133. The responsibilities 139 may be represented by a text description provided by the employer or may be selected from a predefined list of responsibilities. The position prerequisites 143 can indicate the minimum objective qualifications that an employer expects an individual to possess if selected for the position. Examples of position prerequisites 143 can include a minimum level of education (e.g., high-school diploma, associate's degree, bachelor's degree, etc.), a required license or certification (e.g., commercial driver's license, plumber's license, industry certification, etc.), a minimum amount of work experience in the industry 129, and potentially other criteria.

The user profile 126 represents a profile created by a user interested in obtaining employment in an industry 129. The user profile 126 can include contact information 146 for the user, the industry 129 in which the user is interested in obtaining employment, the user qualifications 149 of the user, the user preferences 153 for the user, and potentially other information. The contact information 146 in the user profile can include the name, phone number, email address, mailing address, and similar information for the user. The user qualifications 149 can include objective qualifications of the user, such as his or her level of education, employment history, licenses or certifications, and similar information. The user preferences 153 can indicate a user's personal preferences for employment. For example, user preferences 153 could specify whether a user is willing to relocate for a job, the areas to which a user might be willing to relocate, whether a user is willing to travel as part of his or her job, the amount of travel a user is willing to do as part of his or her job, a user's desired salary or salary range, and potentially other preferences.

The matching service 113 is executed to identify individual user profiles 126 for users that an employer would be interested in interviewing or hiring for an open position 133.

The web server 116 is executed to generate web pages that can be provided to a client device 106 to allow for employers and users to interact with the components of the computing environment 103. For example, the web server 116 may provide web pages that allow a user to create or update a user profile 126, allow employers to create or update an employer profile 123, allow employers to view potential matches between users and open positions 133, or allow employers or users to register. The web server 116 may also be configured to provide web pages to the client device 106, which can provide users or employers with additional functionality.

The client device 106 is representative of a plurality of client devices that may be coupled to the network 109. The client device 106 may include, for example, a processor-based system such as a computer system. Such a computer system may be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 may include one or more displays 156, such as liquid crystal displays (LCDs), gas plasma-based flat panel displays, organic light emitting diode (OLED) displays, electrophoretic ink (“E-ink”) displays, projectors, or other types of display devices. In some instances, the display 156 may be a component of the client device 106 or may be connected to the client device 106 through a wired or wireless connection.

The client device 106 may be configured to execute various applications such as a client application 159 or other applications. The client application 159 may be executed in a client device 106, for example, to access network content served up by the computing environment 103 or other servers, thereby rendering a user interface 163 on the display 156. To this end, the client application 159 may include, for example, a browser, a dedicated application, or other executable and the user interface 163 may include a network page, an application screen, or other user mechanism for obtaining user input. The client device 106 may be configured to execute applications beyond the client application 159 such as, for example, email applications, social networking applications, word processors, spreadsheets, or other applications.

FIG. 1B depicts an example of a user interface 163 according to various embodiments of the present disclosure. Although the example user interface 163 in FIG. 1B is a web page, other user interfaces 163 may be used in various embodiments of the present disclosure. As illustrated, the user interface 163 can be used to display a list of user profiles 126 that match an employer's criteria (e.g., industry type, position(s), etc.). The user interface 163 could include one or more user interface elements 166 that allows a user (e.g., an employer) to sort based on various criteria (e.g., position type, experience, etc.). Individual names of potential employees may be presented as hyperlinks, which, if selected, would allow an employer to view the full user profile 126 of the selected individual. An example of a user interface that shows the user profile 126 of a selected employee is depicted in FIG. 1C.

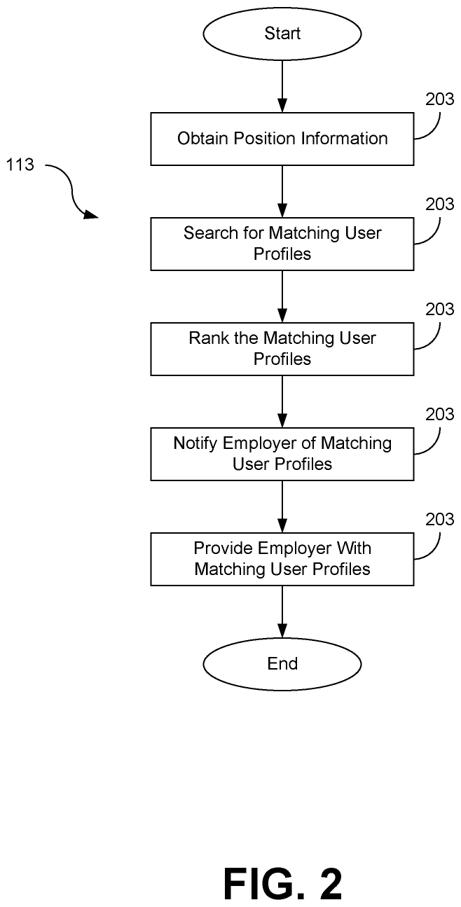

Referring next to FIG. 2, shown is a flowchart that provides one example of the operation of a portion of the matching service 113 according to various embodiments. It is understood that the flowchart of FIG. 2 provides merely an example of the many different types of functional arrangements that may be employed to implement the operation of the portion of the matching service 113 as described herein. As an alternative, the flowchart of FIG. 2 may be viewed as depicting an example of elements of a method implemented in the computing environment 103 according to one or more embodiments.

Beginning with step 203, the matching service 113 obtains information related to an open position 133. This information can include the industry 129 of the employer profile 123 that listed the open position 133, the position prerequisites 143 of the open position 133, the title 136 of the open position 133, and potentially other information.

Then at step 206, the matching service 113 searches for user profiles 126 that match the open position 133. For example, the matching service 116 may identify user profiles 126 that identify the same industry 129 associated with the employer profile 123 that listed the open position 133. The matching service 116 may further select user profiles 126 with at least one user qualification 149 that matches at least one of the position prerequisites 143.

Next at step 209, the matching service 113 ranks the user profiles 126 identified in step 206. For example, the matching service 116 may rank the identified user profiles based on the number of user qualifications 149 that match the position prerequisites 143 listed in the open position 133.

Proceeding to step 213, the matching service 113 notifies the employer of the user profiles 126 that were selected. For example, the matching service 113 may cause a notification to be rendered in a web page presented by the web server 116 to a client device 106. As another example, the matching service 113 may send an email or a short message service (SMS) message to the employer.

Finally, at step 216, the matching service 113 can provide the employer with the user profiles 126 identified in step 306. In some embodiments, the employer may download the user profiles 126 from a web page presented by the web server 116 (e.g., as a database or spreadsheet file). As another example, the employer may view individual user profiles 126 using a web page rendered by the web server 116. This allows for the employer to view each user profile 126 to view additional information, such as the user preferences 153 listed in the user profile 126.

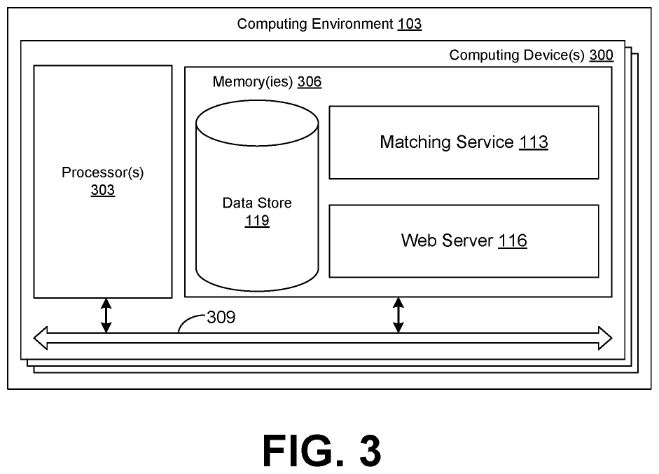

With reference to FIG. 3, shown is a schematic block diagram of the computing environment 103 according to an embodiment of the present disclosure. The computing environment 103 includes one or more computing devices 300. Each computing device 300 includes at least one processor circuit, for example, having a processor 303 and a memory 306, both of which are coupled to a local interface 309. To this end, each computing device 300 may include, for example, at least one server computer or like device. The local interface 309 may include, for example, a data bus with an accompanying address/control bus or other bus structure as can be appreciated.

Stored in the memory 306 are both data and several components that are executable by the processor 303. In particular, stored in the memory 306 and executable by the processor 303 are the matching service 113 and web server 116, and potentially other applications. Also stored in the memory 306 may be a data store 119 and other data. In addition, an operating system may be stored in the memory 306 and executable by the processor 303.

It is understood that there may be other applications that are stored in the memory 306 and are executable by the processor 303 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 306 and are executable by the processor 303. In this respect, the term “executable” means a program file that is in a form that can ultimately be run by the processor 303. Examples of executable programs may be, for example, a compiled program that can be translated into machine code in a format that can be loaded into a random access portion of the memory 306 and run by the processor 303, source code that may be expressed in proper format such as object code that is capable of being loaded into a random access portion of the memory 306 and executed by the processor 303, or source code that may be interpreted by another executable program to generate instructions in a random access portion of the memory 306 to be executed by the processor 303, etc. An executable program may be stored in any portion or component of the memory 306 including, for example, random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory 306 is defined herein as including both volatile and nonvolatile memory and data storage components. Volatile components are those that do not retain data values upon loss of power. Nonvolatile components are those that retain data upon a loss of power. Thus, the memory 306 may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

Also, the processor 303 may represent multiple processors 303 or multiple processor cores and the memory 306 may represent multiple memories 306 that operate in parallel processing circuits, respectively. In such a case, the local interface 309 may be an appropriate network that facilitates communication between any two of the multiple processors 303, between any processor 303 and any of the memories 306, or between any two of the memories 306. The local interface 309 may include additional systems designed to coordinate this communication, including, for example, performing load balancing. The processor 303 may be of electrical or of some other available construction.

Although the matching service 113 and web server 116, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 2 shows the functionality and operation of an implementation of portions of the matching service 113. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor 303 in a computer system or other system. The machine code may be converted from the source code through various processes. For example, the machine code may be generated from the source code with a compiler prior to execution of the corresponding application. As another example, the machine code may be generated from the source code concurrently with execution with an interpreter. Other approaches can also be used. If embodied in hardware, each block may represent a circuit or a number of interconnected circuits to implement the specified logical function or functions.

Although the flowchart of FIG. 2 shows a specific order of execution, it is understood that the order of execution may differ from that which is depicted. For example, the order of execution of two or more blocks may be scrambled relative to the order shown. Also, two or more blocks shown in succession in FIG. 2 may be executed concurrently or with partial concurrence. Further, in some embodiments, one or more of the blocks shown in FIG. 2 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the matching service 113 and web server 116, that includes software or code can be embodied in any non-transitory computer-readable medium for use by or in connection with an instruction execution system such as, for example, a processor 303 in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the matching service 113 and web server 116, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 300, or in multiple computing devices in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine readable instructions stored in the memory that, when executed by the processor, cause the computing device to at least:
obtain information associated with an open position;
identify a plurality of user profiles that match the open position; and
notify an employer of the plurality of user profiles that match the open position.

2. The system of claim 1, wherein the machine readable instructions further cause the computing device to provide the employer with one or more of the plurality of user profiles.

3. The system of claim 2, wherein the machine readable instructions that cause the computing device to provide the employer with one or more of the plurality of user profiles further cause the computing device to at least:
generate a web page;
insert the or more of the plurality of user profiles into the web page; and
send the web page to a client device associated with the employer.

4. The system of claim 1, wherein the machine readable instructions that cause the computing device to notify an employer of the plurality of user profiles that match the open position further cause the computing device to send an email to an address associated with the employer, the email comprising at least a subset of the plurality of user profiles.

5. The system of claim 1, wherein the machine readable instructions that cause the computing device to notify an employer of the plurality of user profiles that match the open position further cause the computing device to send an SMS message to a number associated with the employer, the SMS message comprising a link allowing the employer to view at least a subset of the plurality of profiles.

6. A method, comprising
obtaining information associated with an open position;
identifying a plurality of user profiles that match the open position; and
notifying an employer of the plurality of user profiles that match the open position.

7. The method of claim 6, further comprising providing the employer with one or more of the plurality of user profiles.

8. The method of claim 6, wherein providing the employer with one or more of the plurality of user profiles further comprises:
generating a web page;
inserting the or more of the plurality of user profiles into the web page; and
sending the web page to a client device associated with the employer.

9. The method of claim 6, wherein notifying an employer of the plurality of user profiles that match the open position further comprises sending an email to an address associated with the employer, the email comprising at least a subset of the plurality of user profiles.

10. The method of claim 6, wherein notifying an employer of the plurality of user profiles that match the open position further comprises sending an SMS message to a number associated with the employer, the SMS message comprising a link allowing the employer to view at least a subset of the plurality of profiles.

11. A non-transitory, computer-readable medium, comprising machine-readable instructions that, when executed by a processor of a computing device, cause the computing device to at least:
obtain information associated with an open position;
identify a plurality of user profiles that match the open position; and
notify an employer of the plurality of user profiles that match the open position.

12. The non-transitory, computer-readable medium of claim 11, wherein the machine readable instructions further cause the computing device to provide the employer with one or more of the plurality of user profiles.

13. The non-transitory, computer-readable medium of claim 11, wherein the machine readable instructions that cause the computing device to provide the employer with one or more of the plurality of user profiles further cause the computing device to at least:
generate a web page;
insert the or more of the plurality of user profiles into the web page; and
send the web page to a client device associated with the employer.

14. The non-transitory, computer-readable medium of claim 11, wherein the machine readable instructions that cause the computing device to notify an employer of the plurality of user profiles that match the open position further cause the computing device to send an email to an address associated with the employer, the email comprising at least a subset of the plurality of user profiles.

15. The non-transitory, computer-readable medium of claim 11, wherein the machine readable instructions that cause the computing device to notify an employer of the plurality of user profiles that match the open position further cause the computing device to send an SMS message to a number associated with the employer, the SMS message comprising a link allowing the employer to view at least a subset of the plurality of profiles.
